(19) United States
(12) Patent Application Publication
(10) Pub. No.: US 2021/0191527 A1
(43) Pub. Date: Jun. 24, 2021

(54) KEYBOARD WITH SECONDARY DISPLAY DEVICE

(71) Applicant: HEWLETT-PACKARD DEVELOPMENT COMPANY, L.P., Houston, TX (US)

(72) Inventors: Amol Subhash PANDIT, Fort Collins, CO (US); Peter Andrew SEILER, Fort Collins, CO (US); Matthew FLACH, Fort Collins, CO (US)

(73) Assignee: HEWLETT-PACKARD DEVELOPMENT COMPANY, L.P., Houston, TX (US)

(21) Appl. No.: 16/077,874

(22) PCT Filed: Oct. 7, 2016
(86) PCT No.: PCT/US2016/055906

§ 371 Date: Aug. 14, 2018

(51) Int. Cl. G06F 3/02; G06F 1/16; G06F 3/0488

(52) U.S. Cl. CPC G06F 3/021; G06F 3/04886; G06F 1/1692; G06F 1/1647

(57) ABSTRACT

A system includes: a keyboard to provide user input to a host device, the host device having a primary display device; a secondary display device incorporated with the keyboard; and a secondary display device driver coordinated with a primary display device driver of the host device to accept user input moving displayed items between the secondary display device and the primary display device.

### BACKGROUND

The user interface of a computer includes a display device or monitor and one or more user input devices such as a keyboard, touchpad or mouse. In some devices, the display and user input device are combined by using a touch-sensitive display.

### BRIEF DESCRIPTION OF THE DRAWINGS

The accompanying drawings illustrate various implementations of the principles described herein and are a part of the specification. The illustrated implementations are merely examples and do not limit the scope of the claims.

FIG. 1 is a block diagram of an example keyboard consistent with the disclosed implementations.

FIG. 2A is a block diagram of an example keyboard and host device consistent with the disclosed implementations.

FIG. 2B is a block diagram of an example keyboard and host device consistent with the disclosed implementations.

FIG. 3 is a block diagram of an example computer with a keyboard consistent with the disclosed implementations.

FIG. 4 is a block diagram of another example computer with a keyboard consistent with the disclosed implementations.

FIG. 5 is a flowchart of an example method of making a keyboard consistent with the disclosed implementations.

FIG. 6 is a flowchart of an example method with further details for the method of making a keyboard as shown FIG. 5 consistent with the disclosed implementations.

FIG. 7 is an illustration of an example computer incorporating a keyboard consistent with the disclosed implementations.

FIG. 8 is another illustration of an example computer incorporating a keyboard consistent with the disclosed implementations.

### DETAILED DESCRIPTION

As noted above, the user interface of a computer includes a display device or monitor and one or more user input devices such as a keyboard, touchpad or mouse. In some devices, the display and user input device are combined by using a touch-sensitive display. The convenience of operating the user interface may be a significant factor in the productivity and satisfaction of the user.

Frequently, a user wants more space in which to display applications being used and/or other features of the operating system environment or desktop. In many operating systems, multiple applications can be opened simultaneously, and the user may wish to see data from multiple applications simultaneously on the display of the computer or device being used. Additionally, many applications may have complex menus and taskbars or toolbars that occupy significant space on the display device when that application is in use.

Accordingly, the present specification describes, for example, a keyboard including: a housing; a set of physical keys including alphanumeric keys in the housing; a secondary display device incorporated into the housing; a circuit board; and an interface to interface the keyboard with a host device as an external peripheral of the host device. The circuit board is to communicate with a display driver of a host device that is in communication with the keyboard to coordinate the secondary display device with a primary display device of the host device.

In another example, the present specification describes a computer including: a processor; a memory to provide programming to the processor; a primary display device; a keyboard; and a secondary display device disposed on the keyboard, the secondary display device being smaller in size and having a lower resolution than the primary display device. At least one application of the computer has a first window for display on the primary display device and a second window configured for display on the smaller size and lower resolution of the secondary display device.

In another example, A system includes: a keyboard to provide user input to a host device, the host device having a primary display device; a secondary display device incorporated with the keyboard; and a secondary display device driver coordinated with a primary display device driver of the host device to accept user input moving displayed items between the secondary display device and the primary display device.

As used herein and in the following claims, the term “physical keys” refers to the keys of a keyboard that is real rather than displayed or virtual. Thus, physical keys are distinguished from the keys displayed as part of a virtual keyboard on, for example, a touch-sensitive display device. The physical keys may also be described as mechanical keys or statically assigned keys.

As used herein and in the following claims, the term “host” or “host device” refers to a computerized device that uses peripheral or accessory devices such as a keyboard or display device. For example, a host device may be a computer, whether desktop, laptop or tablet, a server computer, a smartphone or other devices.

As used herein and in the following claims, the term “active application” refers to the application, among any number of open or executing applications, which is to receive the user input then provided. A user may switch between active applications as desired. The active application may be the application that has focus.

As used herein and in the following claims, the term “window” refers to a visual display output by an application for display on a display device. A single application may output multiple windows that are displayed at different or overlapping locations on a primary display or, respectively, on primary and secondary displays, as described herein.

As used herein and in the following claims, the term “desktop” refers to a displayed interface of the computer's operating system in which both applications and features of the operating system are accessible. The desktop may include a taskbar that provides for quick access to chosen applications or features of the operating system.

As used herein and in the following claims, the term “audiovisual application” refers to an application for which the primary purpose is to provide the user with audio or audiovisual output, such as playing music, movies or other audiovisual programs. Thus, audiovisual applications are distinguished from utility applications such as word processors and spreadsheets.

As used herein and in the following claims, the term “teleconferencing application” refers to an application which is to provide a teleconference environment for multiple users to collaborate. This may include audiovisual communication between users as well as shared content on which the users are collaborating.

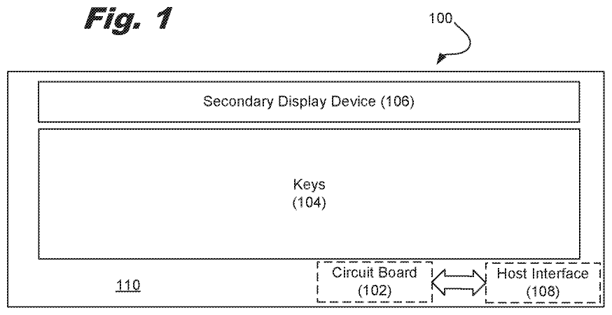

FIG. 1 is a block diagram of an example keyboard consistent with the disclosed implementations. As shown in FIG. 1, the example keyboard (100) includes: a housing (110), a set of physical keys (104) including alphanumeric keys; a secondary display device (106) incorporated into the housing; a circuit board (102); and an interface to interface the keyboard with a host device as an external peripheral of the host device. The circuit board is to communicate with a display driver of a host device that is in communication with the keyboard to coordinate the secondary display device with a primary display device of the host device.

The keyboard (100) may be a separate accessory with its own housing and is interfaced with a host device either by a cable or wirelessly, as described below. The secondary display device (106) is incorporated into the housing (110) of the keyboard (100) and may be adjacent to the physical keys (104) of the keyboard (100) so as to be readily accessible to a user operating the keyboard (100).

The secondary display device (106) is used in conjunction with the primary display device of a host device as will be described in detail herein. In the present example, the secondary display device (106) is operated as an extension of the primary display device meaning that any items or portions of a desktop or open application can be moved between the primary and secondary display devices. The user may provide input indicating what should be displayed on the secondary display device. Having the secondary display device as an extension of the primary display device increases the display space available. Also, the secondary display device allows the user to place displayed items adjacent the keys of the keyboard as is most convenient for overall operation of the host device.

For placement of the secondary display device on the keyboard, it is noted that some standard keys on an alphanumeric keyboard may not be utilized frequently and a corresponding area of a keyboard could therefore be used for other functions. Specifically, such infrequently used keys could be replaced by a secondary display device, as described herein, which can be used for any number of purposes, including standing in for the keys it has replaced when needed. For example, the secondary display device may replace navigation keys, a numeric keypad, keys dedicated to specific infrequently used functions or other infrequently used sets of keys. The secondary display can then provide that functionality when needed, but otherwise serve additional purposes as described herein.

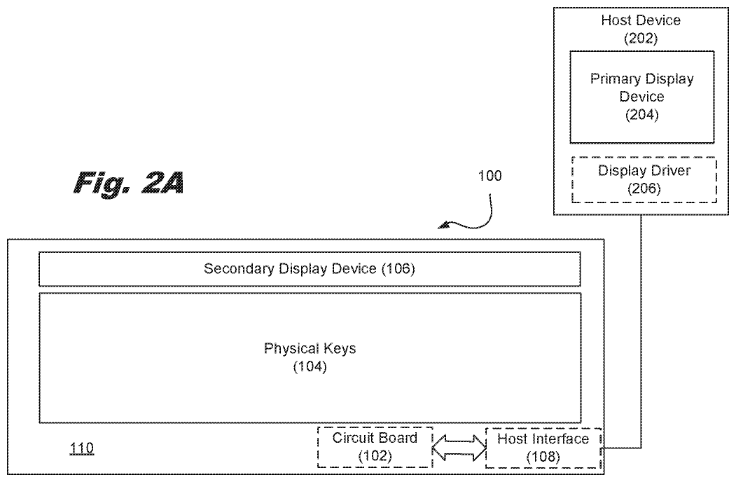

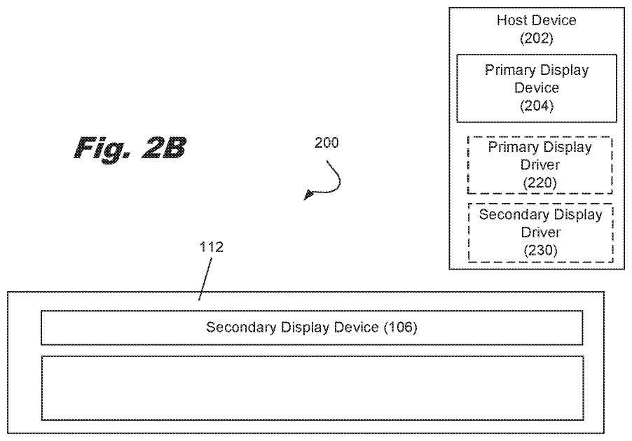

FIG. 2A is a block diagram of an example keyboard and host device consistent with the disclosed implementations. As shown in FIG. 2A, the keyboard (200) again includes a secondary display device (106) located adjacent to a set of physical keys (104).

Within the keyboard, a circuit board (102) is connected with a host interface (108). This interface (108) may be a wired or wireless interface. For example, the interface (108) may be a Universal Serial Bus (USB) interface. Alternatively, the interface (108) may be radio frequency (RF) interface, such a WiFi, WiGiG or Bluetooth interface, or an infrared (IR) or other optical interface. As with FIG. 1, in this illustrated example, the keyboard (200) is a separately housed accessory device that is interfaced, as described here, with a host device.

The host device (202) includes a primary display device (204). As described above, the user may control what elements or features of an open application or desktop are displayed on the secondary display device (106) and which remain on the primary display device (204) of the host device (202).

FIG. 2B is another block diagram of an example keyboard and host device consistent with the disclosed implementations. As shown in FIG. 2B, the system (200) includes: a keyboard (112) to provide user input to a host device (202), the host device (202) having a primary display device (204); a secondary display device (106) incorporated with the keyboard; and a secondary display device driver (230) to cooperate with a primary display device driver (220) of the host device (202) to accept user input moving displayed items between the secondary display device (106) and the primary display device (204).

As described below, the secondary display device (106) may have very different parameters as compared to the primary display device (204). Consequently, the secondary display device (106) will use a separate display driver (230) that is configured to operate with the environment of the secondary display device (106). Under the direction of the Operating System (OS) of the host device, the primary display driver (220) and the secondary display driver (230) will be coordinated so that elements of a single application or desktop may be spread between the two display devices, as described herein.

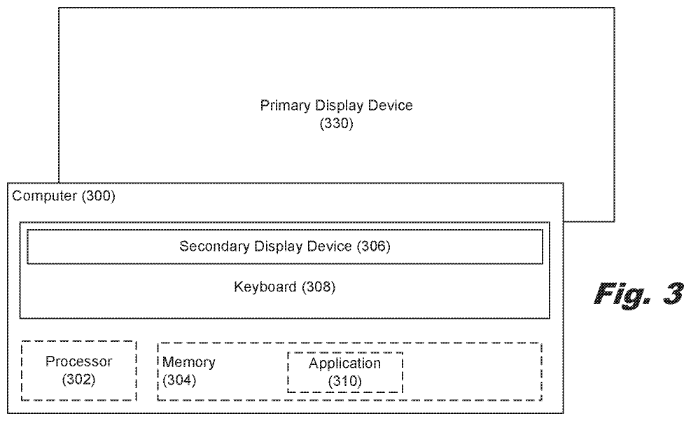

FIG. 3 is a block diagram of an example computer with a keyboard consistent with the disclosed implementations. In the example of FIG. 3, the keyboard (308) is incorporated into a host computer (300).

As shown in FIG. 3, a computer (300) includes: a processor (302); a memory (304) to provide programming to the processor (302); a primary display device (330); a keyboard (308); and a secondary display device (306) disposed on the keyboard (308), the secondary display device being smaller in size and having a lower resolution than the primary display device. The computer (300) also includes at least one application (310) that has a first window for display on the primary display device (330) and a second window configured for display on the smaller size and lower resolution of the secondary display device (306).

The processor (302), which may be referred to as a central processing unit (CPU), is in communication with the memory (304). The memory (304) represented both the volatile and non-volatile memory of a computer. The operating system is stored in the non-volatile memory of the computer (300) and instantiated by the processor (302) using volatile memory, such as Random Access Memory (RAM), during boot up.

As stated, the secondary display device (306), in this example, is a much simpler display device than the primary display. Specifically, the secondary display device is smaller in size than the primary display device. For example, a primary display may have 1920×1080 pixels, whereas the secondary display device may have only 600×70 pixels. Also, the secondary display device may have a lower refresh rate, a lower contrast maximum and/or fewer displayable colors as compared to the primary display device.

As described above, the user may control what elements or features of an open application or desktop are displayed on the secondary display device (306) and which remain on the primary display device (330) of the host device (300). In various examples described herein, the application or a desktop may be configured to divide its visual input into multiple windows. In particular, a menu or taskbar of an application or a toolbar of a desktop may be separated into a second window. This second window may be configured for the limitations of the secondary display device by the application or by the driver for the secondary display device. For example, the application or driver may size the window for the secondary display device, may adjust a size or resolution of icons in the second window for better display on the secondary display device, may halftone contents of the second window for better appearance with limited color depth, or the like. The application or driver may dynamically configure the second window based on the user moving the second window to the secondary display device. The application or driver may determine a configuration for the second window based on the application being launched or the secondary display device being detected, or the application or driver may determine the configuration based on the second window being moved to the secondary display device.

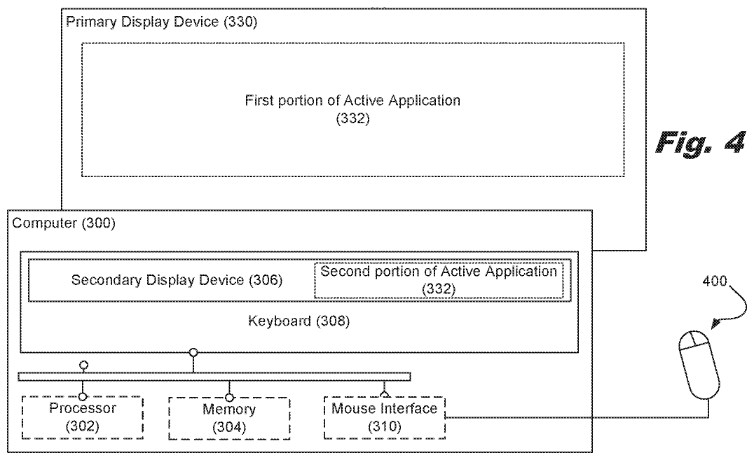

FIG. 4 is a block diagram of another example computer with a keyboard consistent with the disclosed implementations. As shown in FIG. 4, the computer (300) again includes a primary display device (330) and a keyboard (308) with a secondary display device (306).

FIG. 4 also shows a bus providing communication between the processor (302), the memory (304) and the keyboard (308). The bus also connects a user input device, in the illustrated example, a mouse (400). The user can operate the mouse (400) to control what is displayed on the secondary display device (306).

In the illustrated example, the computer (300) has an active application into which user input from the keyboard or mouse will be entered until a new active application is invoked. As shown in FIG. 4, a first portion of the active application (332) is displayed on the primary display device (330), while a second portion of the active application (332) is displayed on the secondary display device (306).

The user, operating the mouse (400), can select a portion of the active application on the primary display device (330) and move that selected portion, by a drag-and-drop action, to the secondary display device (306). As indicated above, an application may be configured to split itself between multiple windows, for example, putting a menu or toolbar in a separate window. The drag-and-drop action described may initiate this splitting of the application's display between multiple windows. The smaller window can then be positioned by the same or separate drag-and-drop operation for display on the secondary display device. In this way, the user can optimally organize the presentation of active application portions according to that user's needs as between the primary display device (330) and the secondary display device (306).

Examples of portions of an active application that may be usefully displayed on the secondary display device (306) will be given below. However, because the secondary display device is operated as an extension of the primary display device, any desired element or portion of the active application may be moved to the secondary display device or from the secondary display device to the primary display device. The processor may automatically scale any portion of the active application displayed on the secondary display device for optimal presentation in the display space of the secondary display device.

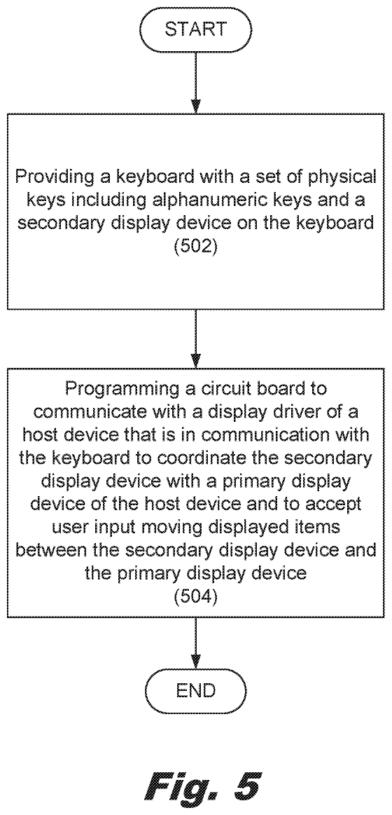

FIG. 5 is a flowchart of an example method of making a keyboard consistent with the disclosed implementations. As shown in FIG. 5, the method includes: providing (502) a keyboard with a set of physical keys including alphanumeric keys and a secondary display device on the keyboard; and programming (504) a circuit board to communicate with a display driver of a host device that is in communication with the keyboard to coordinate the secondary display device with a primary display device of the host device and to accept user input moving displayed items between the secondary display device and the primary display device.

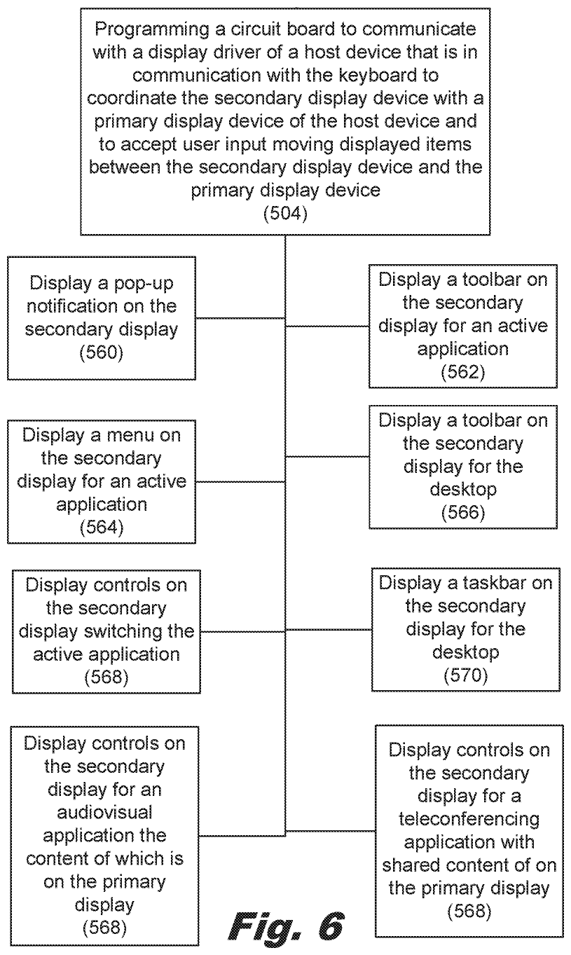

FIG. 6 is a flowchart of an example method with further details for the method of making a keyboard as shown FIG. 5 consistent with the disclosed implementations. As shown in FIG. 6, these additional features may be part of programming (504) a circuit board to communicate with a display driver of a host device that is in communication with the keyboard to coordinate the secondary display device with a primary display device of the host device and to accept user input moving displayed items between the secondary display device and the primary display device.

A pop-up or pop-up notification is an element that is displayed by a host device in response to the occurrence of an event other than input the user is then providing to an active application. A pop-up notification may be displayed for a limited time and then disappear. The pop-up notification may have originated from the active application, another open application, a running service, or from the operating system, for example. The pop-up will occupy some amount of display space and may, inconveniently, interfere with or cover a portion of the active application display in which the user is then working.

Consequently, the user may adjust a setting in the operating system or elsewhere to direct that all pop-up notifications are to be displayed (560) on the secondary display device rather than the primary display device. This may minimize the likelihood that a pop-up notification will directly inconvenience the user in operating an active application while still providing immediate visual access to the pop-up notification.

As noted above, some applications may have elaborate multi-tiered menus or may have toolbars providing shortcuts within the application. These elements, while very helpful, take up display space that cannot then be used by other portions of the active application, such as the central workspace of the active application. Consequently, the illustrated method may include receiving user input to display (562) a toolbar for an active application on the secondary display device or to display (564) a menu for an active application on the secondary display device.

As noted above, this user input may be provided by a drag-and-drop action of the menu or toolbar from the primary display device to the secondary display device. Similarly, this action can be reversed to return a displayed element from the secondary display device to the primary display device. An element returning to the primary display device may automatically snap to a determined display location within the portion of the active application on the primary display device or may stay where dropped by the user. Alternatively, the user may adjust other settings in the active application or elsewhere that will put display of the menu or toolbar on the secondary display device.

In another example, a user may have two or more documents open at the same time in the active application. The secondary display device can provide controls for switching between the two or more documents, just as it can be used to switch between active applications.

Similarly, the desktop of the operating system of the host device may include a taskbar. This taskbar may facilitate access to different applications, switching between active applications, displaying active services or background applications, or invoking other features of the operating system. This taskbar may also be displayed (570) on the secondary display device to increase the display space available to the rest of the desktop on the primary display device. As above, the taskbar may be moved to or from the secondary display device by any user control mechanism including adjusting specific settings or by drag-and-drop. Alternatively, the taskbar may be replicated on both the primary display and the secondary display for redundant access to switching applications or accessing options.

As noted above, an “audiovisual application” is an application for which the primary purpose is to provide the user with audio or audiovisual output, such as playing music, movies or other audiovisual programs. Examples of audiovisual applications include MP3 players, media players, CD/DVD/Blu-ray players, media streaming applications and others.

To facilitate operation of audiovisual applications on the host device, the method of FIG. 6 includes displaying (568) controls on the secondary display device. This leaves the entire primary display device for displaying the audiovisual content being watched. This approach both maximizes the size of the content display while keeping the controls for the application readily available. Without a secondary display device for this purpose the user may have to inconveniently bring up controls on the primary display before the content can be paused or otherwise controlled.

In another example, within the context of audiovisual applications, the audiovisual application may be a gaming application. In which case, again, the secondary display device may be used to display game controls or an interface for acting with other connected gamers during a game. The main action of the game can then occupy the entirety of the primary display device.

A “teleconferencing application” is an application which is to provide a teleconference environment for multiple users to communicate. This may include audiovisual communication between users as well as shared content on which the users are collaborating.

To facilitate collaboration in a teleconferencing application, the present method of FIG. 6 may also include to display (568) controls for the teleconferencing application on the secondary display device. This may leave the entire display space of the primary display device available to content which is the subject of discussion in the teleconference or on which the users a collaborating, for example, presentation slides, files or information. The controls on the secondary display device may include a mute function, volume control, a chat feature, a direct call making function, a disconnect command and/or indications of who the participants are including, in some cases, a video feed of each participant.

In addition, some of these examples, the secondary display device may be a touch-sensitive display device. In this way, if a menu, taskbar or other user controls are displayed on the secondary display device, the user can simply touch a desired option on the secondary display device to invoke that application or function. However, the secondary display device need not necessarily be a touch-sensitive display device. Options on the secondary display device can be selected using a mouse or cursor rather than by touch. Where the secondary display device is a touch-sensitive display device the secondary display driver will include or operate with a touch input driver.

In another example, the secondary display device described herein could be used to provide a place where the user places quick links or other icons that are frequently used and which remain available on a touch-sensitive secondary display device as needed. In this case, the menu on the secondary display device is not necessarily tied to any particular application or to the desktop, but contains functions that the user has collected for quick access adjacent to the physical keys of the keyboard.

The collected options on the secondary display device need not even be tied to the operating system of the host, but may be operate with the Basic Input/Output System (BIOS) of the host device. The options on the secondary display may include operating system or BIOS controlled settings such as wireless enable/disable, volume control, sleep or hibernate, display brightness and other display settings. In such a case, the driver for the secondary display device might have Windows Management Instrumentation (WMI) calls to talk to BIOS-exposed options. The BIOS would make these functions accessible, while the driver would initiate the control of these settings.

Additionally, if the keyboard with secondary display device is a separate accessory to the host, a touch-sensitive secondary display device may give more immediate access to the display options if the keyboard is located some distance from the host or the primary display device.

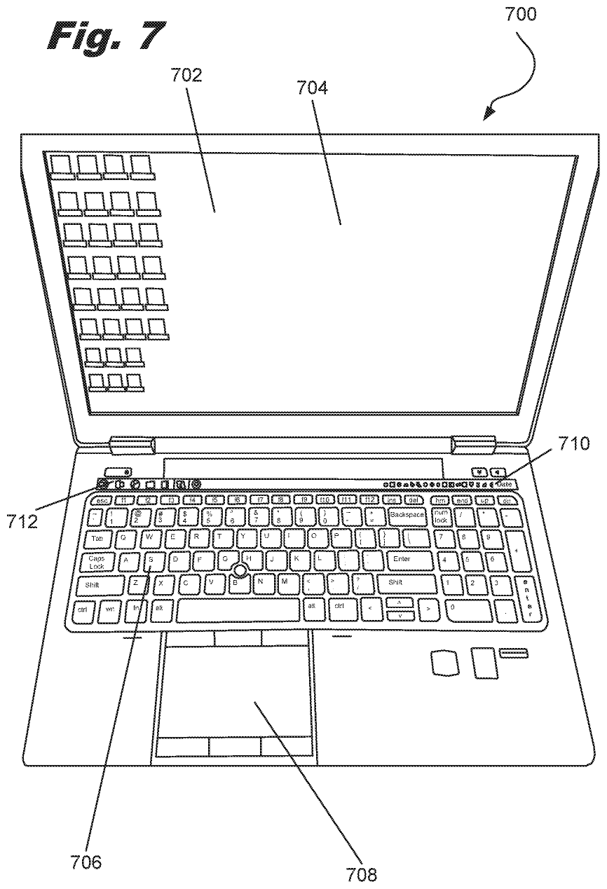

FIG. 7 is an illustration of an example computer incorporating a keyboard consistent with the disclosed implementations. In the example of FIG. 7, the computer (700) is a laptop computer with a primary display device (702), a keyboard (706) of physical keys and a trackpad or touchpad (708). The keyboard (706) incorporates an adjacent secondary display device (710) as described herein.

As shown in FIG. 7, the primary display device (702) may be displaying a desktop (704) of the operating system. To maximize the display space available for the desktop (704), a taskbar (712) for the desktop has been moved for display on the secondary display device (710). The content of the taskbar may be customized by the user. In this example, the secondary display device may be a touch-sensitive display device so that the user can select options from the displayed taskbar by touching the icon for that option on the secondary display device.

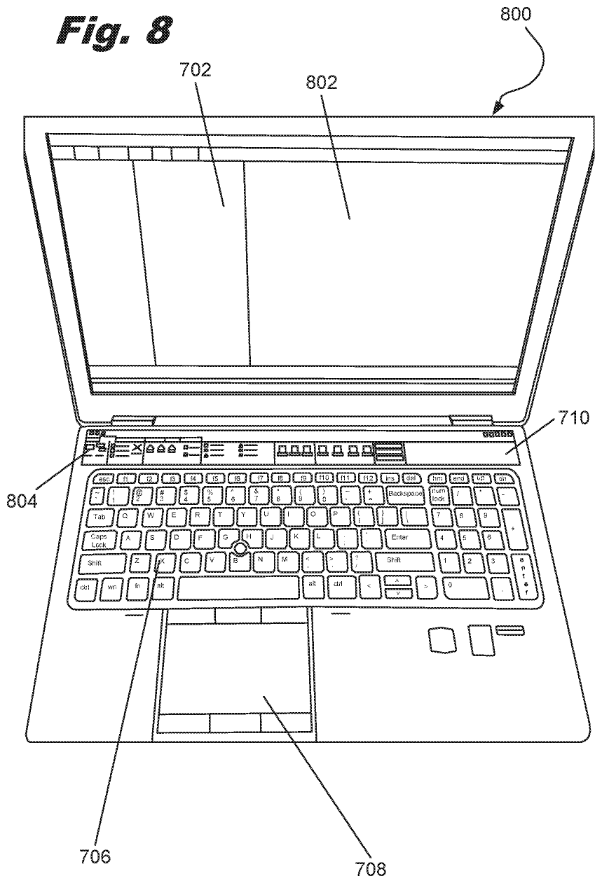

FIG. 8 is another illustration of an example computer incorporating a keyboard consistent with the disclosed implementations. In the example of FIG. 8, the computer (800) is a laptop computer with a primary display device (702), a keyboard (706) of physical keys and a trackpad or touchpad (708). The keyboard (706) incorporates an adjacent secondary display device (710) as described herein.

As shown in FIG. 8, the primary display device (702) may be displaying an active application (802). The active application (802) may be, for example, an email application, a web browser, a word processor, a spreadsheet or any other computer application.

To maximize the display space available for the active application (802), a menu or toolbar (804) for the active application (802) has been moved for display on the secondary display device (710). In some cases, the content of the toolbar or menu may be customized by the user. In this example, the secondary display device may be a touch-sensitive display device so that the user can select options from the displayed menu or toolbar by touching the icon for that option on the secondary display device.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A keyboard comprising:
a housing;
a set of physical keys including alphanumeric keys in the housing;
a secondary display device incorporated into the housing;
a circuit board; and
an interface to interface the keyboard with a host device as an external peripheral of the host device;
the circuit board to communicate with a display driver of a host device that is in communication with the keyboard to coordinate the secondary display device with a primary display device of the host device.

2. The keyboard of claim 1, wherein the secondary display device is a touch-sensitive display device.

3. The keyboard of claim 1, the keyboard to display a toolbar for an application active on the primary display device on the secondary display device.

4. The keyboard of claim 1, the keyboard to display pop-up notifications on the secondary display device rather than on the primary display device.

5. The keyboard of claim 1, the keyboard to display a toolbar for a desktop of the primary display device on the secondary display device.

6. The keyboard of claim 1, the circuit board to signal the host device to switch between active applications on the primary display based on input to the secondary display device.

7. The keyboard of claim 1, wherein the interface is a wireless interface.

8. A computer comprising:
a processor;
a memory to provide programming to the processor;
a primary display device;
a keyboard;
a secondary display device disposed on the keyboard, the secondary display device being smaller in size and having a lower resolution than the primary display device; and
at least one application having a first window for display on the primary display device and a second window configured for display on the smaller size and lower resolution of the secondary display device.

9. The computer of claim 8, the processor to display a menu of the application on the secondary display device and a remainder of the application on the primary display device.

10. The computer of claim 8, the processor to display a desktop task bar of the desktop on the secondary display device and a remainder of the desktop on the primary display device.

11. The computer of claim 8, further comprising an audiovisual application, wherein the processor is to display content of the audiovisual application on the primary display device and user controls for the audiovisual application on the secondary display device of the keyboard.

12. The computer of claim 8, further comprising a teleconferencing application, wherein the processor is to display a shared view of content for the teleconferencing application on the primary display device and user controls for the teleconferencing application on the secondary display device of the keyboard.

13. The computer of claim 8, wherein the secondary display device is a touch-sensitive display device.

14. A system comprising:
a keyboard to provide user input to a host device, the host device having a primary display device;
a secondary display device incorporated with the keyboard; and
a secondary display device driver coordinated with a primary display device driver of the host device to accept user input moving displayed items between the secondary display device and the primary display device.

15. The system of claim 14, wherein the secondary display device is arranged in common plane with keys of the keyboard.
